(19) United States
(12) Patent Application Publication
(10) Pub. No.: US 2015/0189425 A1
(43) Pub. Date: Jul. 2, 2015

(54) MOBILE DEVICE SPEAKER CONTROL

(71) Applicant: Hawk Yin Pang, San Jose, CA (US)

(72) Inventor: Hawk Yin Pang, San Jose, CA (US)

(73) Assignee: AliphCom, San Francisco, CA (US)

(21) Appl. No.: 14/144,499

(22) Filed: Dec. 30, 2013

(51) Int. Cl. H04R 3/00

(52) U.S. Cl. CPC H04R 3/00

(57) ABSTRACT

Techniques for mobile device speaker control are described, including detecting a device within a proximity of a speaker box coupled to a data network, filtering a data packet received from the device to determine a received signal strength associated with the device, comparing the received signal strength to a threshold, and determining whether an action is to be performed based on a result of the comparing the received signal strength to the threshold.

### CROSS-REFERENCE TO RELATED APPLICATIONS

This application claims the benefit of U.S. Provisional Patent Application No. 61/748,075 filed on Jan. 1, 2013, which is incorporated by reference herein for all purposes. This applications also is related to U.S. Nonprovisional patent application Ser. No. 14/______ filed Dec. XX, 2013 with Attorney Docket No. ALI-192 and entitled “Mobile Device Speaker Control,” and U.S. Nonprovisional patent application Ser. No. 14/______ filed Dec. XX, 2013 with Attorney Docket No. ALI-266 and entitled “Mobile Device Speaker Control,” all of which are incorporated by reference for all purposes.

### FIELD

Embodiments of the present invention relate generally to electrical and electronic hardware, audio equipment, wired and wireless network communications, data processing, and computing devices, including mobile and wearable computing devices. More specifically, devices, techniques, and computer-readable media for mobile device speaker control are described.

### BACKGROUND

In conventional speaker systems, there are solutions for controlling individual speakers or using a control component for managing a group of speakers. However, these conventional solutions rely upon wired connections or, in the case of wireless connections, individual speakers are often controlled by a single device, which is often inflexible and confines media to that selected using the single control device. Further, conventional solutions are often time-consuming and technically complex to set up and manage, often requiring extensive training or expertise to operate.

Conventional media playback solutions are typically found in mobile devices such as mobile phones, smart phones, or other devices. Unfortunately, conventional speaker control devices are often limited connections between a mobile device and a single speaker. Further, a range of actions that can be taken are often limited to the device that is in data communication with a given speaker. If different users with different playlists and mobile devices want to use a given speaker, individual connections often need to be established manually regardless of the type of data communication protocol used.

Thus, what is needed is a solution for speaker control without the limitations of conventional techniques.

### BRIEF DESCRIPTION OF THE DRAWINGS

Various embodiments or examples (“examples”) are disclosed in the following detailed description and the accompanying drawings:

FIG. 1A illustrates an example of a mobile device speaker control system, according to various embodiments;

FIG. 1B illustrates another example of a mobile device speaker control system, according to some embodiments;

FIGS. 2A to 2C illustrate examples of implementing mobile device speaker control, according to some embodiments;

FIGS. 3A to 3C illustrate alternative examples of implementing mobile device speaker control, according to some embodiments;

FIG. 4 illustrates an example of a controller configured to implement mobile device speaker control, according to various embodiments;

FIG. 5 illustrates some exemplary actions determined using mobile device speaker control, according to some examples;

FIGS. 6A and 6B illustrate examples of mobile device architecture for mobile device speaker control, according to some embodiments

FIG. 7 is an example flow for facilitating mobile device speaker control, according to some embodiments;

FIG. 8 is an alternative example flow for facilitating mobile device speaker control, according to some embodiments;

FIG. 9 illustrates an exemplary computer system suitable for use with mobile device speaker control, according to some examples;

FIG. 10 depicts an alternative example of a controller implemented to facilitate mobile device control of a speaker box, according to some embodiments;

FIG. 11 is an example flow for facilitating mobile device speaker control, according to some embodiments;

FIG. 12 is an alternative example flow for facilitating mobile device speaker control, according to some embodiments; and

FIG. 13 illustrates an exemplary computing platform in accordance with various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

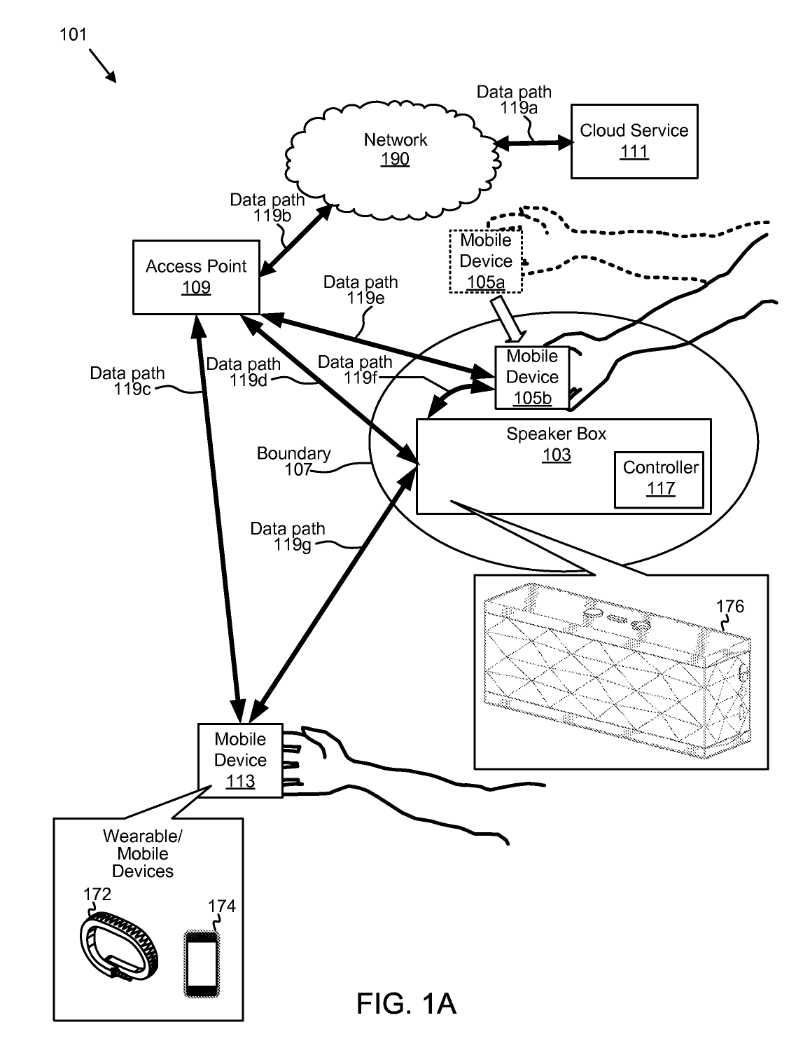

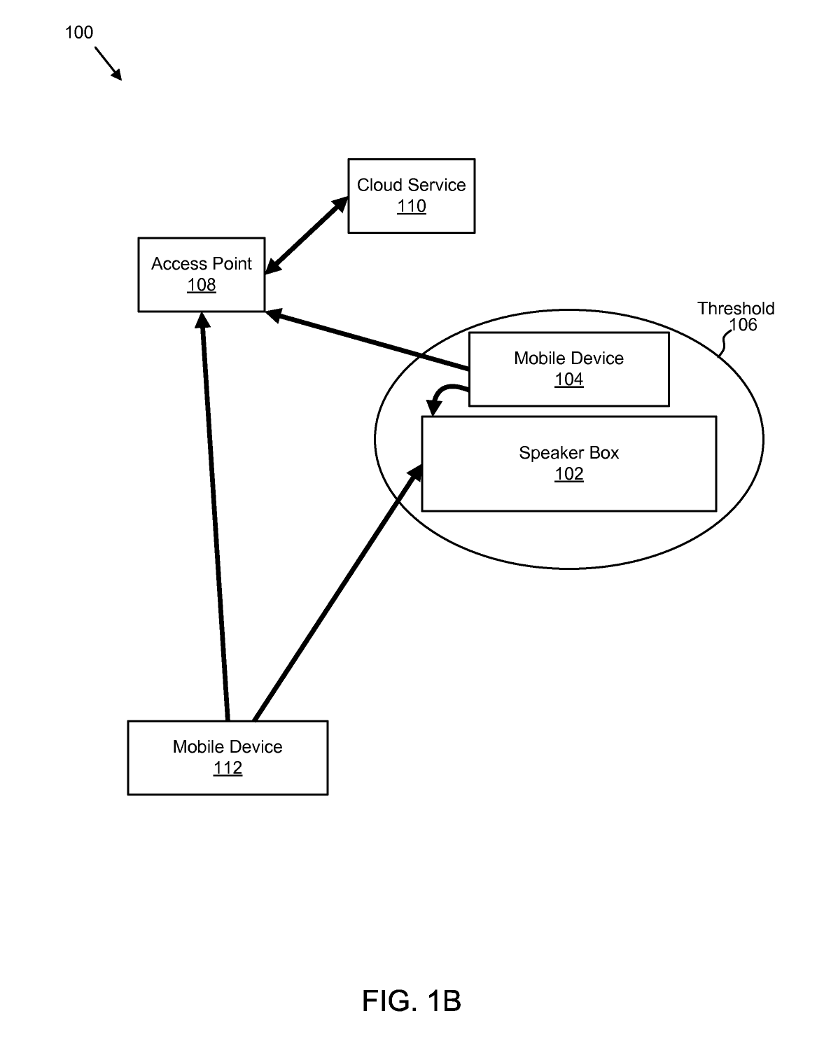

FIG. 1A illustrates an example of a mobile device speaker control system, according to various embodiments. Diagram 101 includes a speaker box 103, a mobile device 105, a boundary 107, a wireless access point 109, a cloud service 111, and a mobile device 113. Speaker box 103, mobile device 105, wireless access point 109, cloud service 111, and mobile device 113, may be configured for wired or wireless data communication over, for example, data paths 119a to 119g. Speaker box 103, at least in some examples, may refer to any type of speaker, speaker system, speaker network, single or group of speakers (e.g., transducers) configured to render audible various types of media including music, song, audio, video, multi-media, or other types of media, without limitation to format, protocol, or other technical characteristics. Thus, speaker box 103 can implement the speakers and/or transducers to generate sound waves or acoustic energy signals in the audible frequency range of, for example, 20 Hz to 20 kHz. In some cases, speaker box 103 can implement the speakers and/or transducers to generate sound waves or acoustic energy for purposes of transmitting control information/data in either the audible or inaudible frequency ranges, or both.

Further to diagram 101, speaker box 103 is shown to include a controller 117 that is configured to control interactions between one or more mobile computing devices and speaker box 103, and further configured to determine a subset of mobile devices that are granted control of the operation of at least a portion of speaker box 103. According to some embodiments, mobile computing devices, such as mobile devices 105 and 113, can communicate with speaker box 103 to transmit and/or receive data for controlling or implementing the generation of audio. Controller 117 is configured further to determine which of mobile devices 105 and 113 is in a control state in which at least one of mobile devices 105 and 113 is assigned or awarded control of speaker box 103. In at least some examples, controller 117 determines a control state for mobile devices 105 and 113 relative to a boundary 107, which can represent a physical dimension, threshold, or characteristic, as well as a conceptual threshold, a derived representation of a parameter with which to determine control, and the like.

In the example shown, boundary 107 can represent proximity relative to speaker box 103 or some other reference point. As such, as mobile device 105 is translated from a position 105a to a position 105b, the mobile device crosses boundary 107. Controller 117 can determine the transition over a region or boundary 107 defining proximity, and, in response, can assign or award control to mobile device 105. In some examples, controller 117 can assign or award sole control of speaker box 103 to mobile device 105. In other examples, controller 117 may designate mobile device 105 as having a control state indicating primary, principal or supreme control, with subsidiary control optionally provided to one or more other mobile devices, such as mobile device 113, which is beyond boundary 107. Subsidiary control can refer to temporary or limited control based on, for example, a subsequent time that a secondary mobile device passes into boundary 107.

As used herein, mobile devices 105 and 113 may be implemented as smart phones, mobile phones, cell phones, mobile computing devices (e.g., tablet computers, laptop computers, notebook computers, or any other portable or mobile computer, without limitation, including wearable computing devices), personal digital assistants (i.e., “PDA”), portable media devices, electronic readers, and the like, without limitation. As shown, mobile devices 105 and 113 may be implemented as wearable computing devices 172, mobile computing device 174, and the like. An example of a suitable wearable device 172, or a variant thereof, is described in U.S. patent application Ser. No. 13/454,040, which is incorporated herein by reference.

Further, mobile devices 105 and 113, as well as speaker box 103, may be configured to access wireless access point 109 to retrieve data via network(s) 190 from cloud service 111, which may also be in direct or indirect data communication with one or more data sources, such as databases, repositories, or other data storage facilities (not shown). In some cases, these data sources can be collectively referred to “data sources.” In some examples, an owner, manufacturer, or partner associated with speaker box 103 can provide data representing a list of characteristics of mobile devices (e.g., stored in a data source) that have interfaced with an equivalent speaker box 103 (e.g., another product manufactured as speaker box 103). That is, controller 117 can detect characteristics of mobile devices, such as one or more identifiers, and can upload those characteristics to one of a number of cloud services 111. Thereafter, the characteristics (e.g., identifiers) can be made available to other speaker boxes 103. In other examples, third parties may implement cloud services as platforms configured to provide audio/music streaming. Examples of such cloud services include Spotify™, Rdio™, Songza™, and the like, as well as social networking platforms, such as Facebook®, and the like. Such audio streaming services can provide audio tracks songs, and other metadata, including characteristics (e.g., identifiers) of mobile devices 105 and 113. Therefore, when mobile device 105 accesses cloud service 111 to fetch audio data to be played on speaker box 103, associated characteristics (e.g., identifiers, such as MAC addresses) can be transmitted to speaker box 103.

In some examples, controller 117 can access data packets that are transmitted by mobile device 105 or 113, regardless of whether the packets are encrypted or unencrypted. Controller 117 can implement a boundary 107, which can correspond to a threshold against which to determine proximity, to determine which of mobile device 105 or 113 may control or interface with speaker box 103. In some examples, if a characteristic of mobile device 105 surpasses a threshold value represented by boundary 107, then controller 117 may prioritize mobile device 105 over mobile device 113 for control of speaker box 103.

In some examples, prioritization may be performed by ranking, categorizing, or otherwise ordering at least a characteristic of mobile devices 105 and 113. An example of such a characteristic is an identifier, such as an address associated with mobile devices 105 and 113. An address can be a media access control (i.e., “MAC”) address, an internet protocol (i.e., “IP”) address, a Bluetooth® MAC address, or other type of address that may be used to identify mobile devices 105 and 113, as well as speaker box 103 or access point 109. Other identifiers or characteristics are possible.

Controller 117 can be configured to identify mobile devices 105 and 113 using identifiers, and can be further configured to associate each identifier with a value representing whether mobile devices 105 and 113 is within boundary 107. In the example shown, controller 117 can prioritize mobile device 105 (and its identifiers) based on a value representing its presence within boundary 107 relative to another value representing that mobile device 113 is not within boundary 107. Thus, controller 117 may be used to award or assign control of speaker box 103 to mobile device 105, in some examples.

As described above, the threshold comparison and determination of control and, as described below, other actions that may be taken may be initiated and performed when mobile device 105 is brought in close proximity to speaker box 103. In other examples, mobile device 105 may also be brought in close proximity to another device (not shown) apart from speaker box 103 that may be used for configuring control of speaker box 103. Using the techniques described herein, proximity may be determined using a variety of techniques to determine a distance or proximity of a source device (i.e., a mobile device having media that has played may be positioned adjacent to, or on top of, speaker box 103). As an example, when a mobile device (e.g., mobile device 105, 113), or other type of media device, is brought in close proximity to speaker box 103 (e.g., as determined by near field communication protocols, such as within a few inches (e.g., less than 20 to 50 mm), or as determined by far field communication protocols, such as within 20 or 30 yards (e.g., “WiFi”), among other ranges), control may be established After establishing control, controller 117 can initiate or perform actions to allow media to be played using speaker box 103. In still other examples, note that controller 117 and the elements described herein may be implemented differently in function, structure, configuration, or other aspects and are not limited to those shown and described.

According to some embodiments, speaker box 103 can be configured to play files (e.g., execute instructions to render audio data in files as audible sound waves) that may be digitally-encoded without limitation to data formats, types, or data communication protocols (e.g., Bluetooth®, Bluetooth Low Energy, and variants thereof, Wi-Fi (also used interchangeably herein with “WiFi,” “wifi,” or variants thereof, without limitation), ZigBee, Near Field Communications (“NFC”), or others, without limitation). Speaker box 103 may also be configured to encode, decode, encrypt, or decrypt data for use with the techniques described herein. Speaker box 103 may, in some examples, be implemented using a device 176, such as the JAMBOX™, or equivalent, developed by AliphCom of San Francisco, Calif., an equivalent thereof, or any variant thereof. Note that while in some examples, as described, a mobile device is used to control a speaker box, various embodiments are not limited to facilitating the control of a speaker box, and are relevant to the control of any electronic device.

FIG. 1B illustrates an example of a mobile device speaker control system, according to some embodiments. The diagram of FIG. 1B depicts a system 100 includes speaker box 102, mobile device 104, received signal strength indicator (RSSI) threshold 106, Wi-Fi access point 108, cloud service 110, and mobile device 112. In some examples, speaker box 102 may refer to any type of speaker, speaker system, speaker network, single or group of speakers configured to render audible various types of media including music, song, audio, video, multi-media, or other types of media, without limitation to format, protocol, or other technical characteristics. Speaker box 102, in some examples, may be configured for wired or wireless data communication in order to play files that may be digitally encoded without limitation to data formats, types, or data communication protocols. Speaker box 102 may also be configured to encode, decode, encrypt, or decrypt data for use with the techniques described herein. Speaker box 102 may, in some examples, be implemented using a device such as the JAMBOX™ from AliphCom of San Francisco, Calif.

As used herein, mobile devices 104 and 112 may be implemented as smart phones, mobile phones, cell phones, mobile computing devices (e.g., tablet computers, laptop computers, notebook computers, or any other portable or mobile computer, without limitation), personal digital assistants (i.e., “PDA”), portable media devices, electronic readers, and the like, without limitation. Mobile devices 104 and 112 and speaker box 102 may be configured to access Wi-Fi access point 108 in order to retrieve data from cloud service 110, which may also be in direct or indirect data communication with one or more data sources, databases, repositories, or other data storage facilities (not shown).

In some examples, encrypted or unencrypted data packets may be transferred by mobile device 104 or 112 to speaker box 102. However, threshold 106 may be used to determine which of mobile device 104 or 112 may control or interface with speaker box 102. As an example, a received signal strength indicator (RSSI) may be detected for each of mobile devices 104 and 112 and used in a comparison against a pre-set received signal strength threshold (i.e., threshold 106). If the RSSI for mobile device 104 is greater than threshold 106 and the RSSI for mobile device 112 is less than threshold 106, mobile device 104 may be prioritized over mobile device 112 for control of speaker box 102. In some examples, prioritization may be performed by ranking, prioritizing, or otherwise listing an address (e.g., media access control (i.e., “MAC”), internet protocol (i.e., “IP”), or other type of address that may be used to identify mobile device 104, mobile device 112, speaker box 102, or Wi-Fi access point 108 (hereafter referred to as “access point 108”).

If mobile device 104 is prioritized (i.e., listed by MAC address as having a RSSI that is greater than threshold 106 and greater than that of mobile device 112 or any other mobile device (not shown)) higher than other mobile devices (e.g., mobile device 112), then system 100 may be used to award or assign control of speaker box 102 to mobile device 104, in some examples. As shown, access point 108 may be configured to handle any type of wired or wireless data communication protocol such as Wi-Fi, among others. As described above, the threshold comparison and determination of control and, as described below, other actions that may be taken may be initiated and performed when mobile device 104 is brought in close proximity to speaker box 102. In other examples, mobile device 104 may also be brought in close proximity to another device apart from speaker box 102 that may be used for configuring control of speaker box 102. Using the techniques described above, proximity may be determined using a variety of techniques to determine a distance or proximity of a source device (i.e., a device having media that may be played on speaker box 102). In some examples, using pre-installed antennas and applications, speaker box 102 or another device (not shown) may be used to control speaker box 102. As an example, when a mobile device or other type of media device (e.g., mobile device 104, 112) is brought in close proximity to speaker box 102 (e.g., NFC within a few inches or Wi-Fi within 20 or 30 yards), control may be established. Further, after establishing control, actions may be initiated or performed to allow media to be played through speaker box 102. In still other examples, system 100 and the above-described elements may be implemented differently in function, structure, configuration, or other aspects and are not limited to those shown and described.

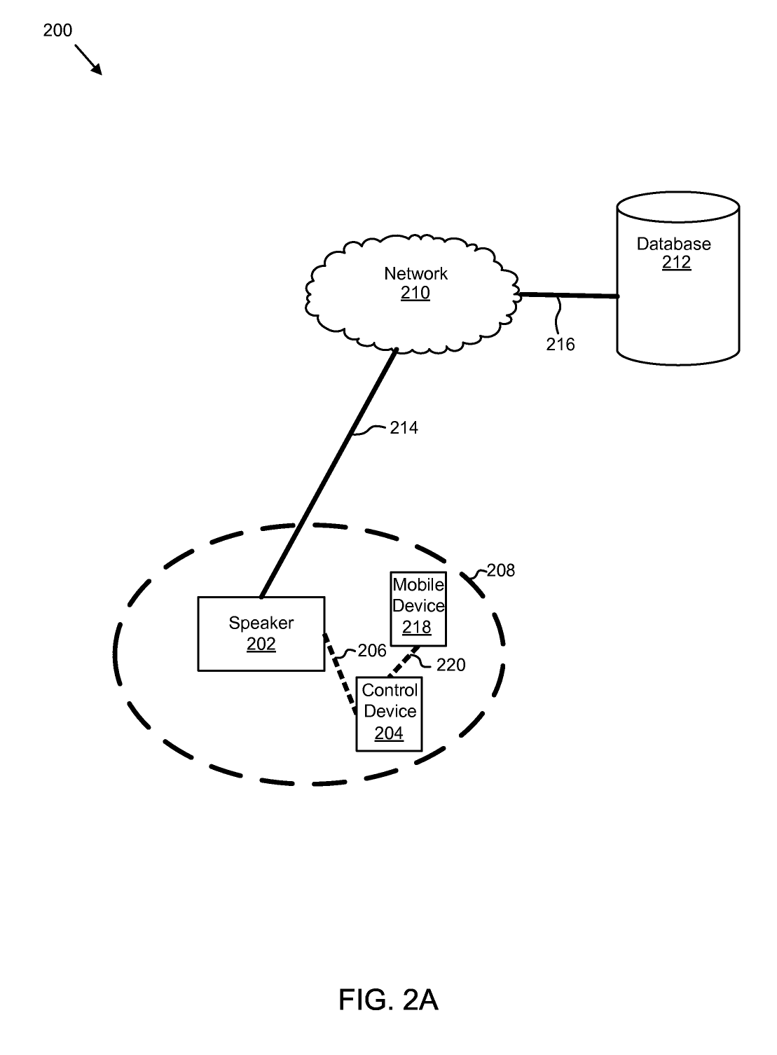

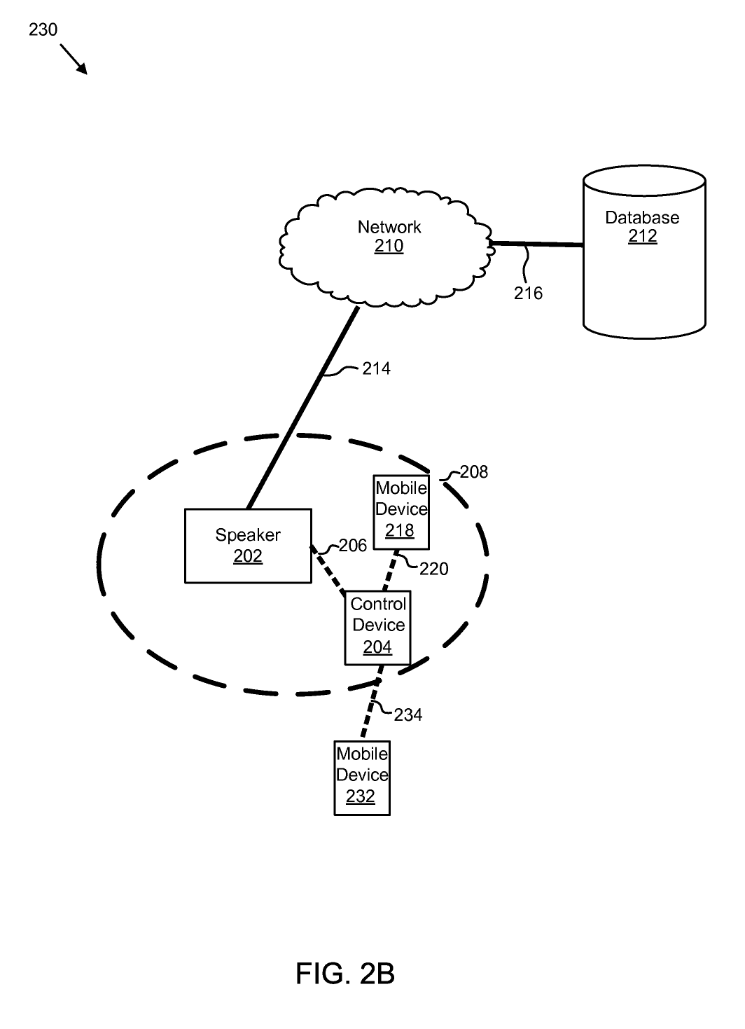

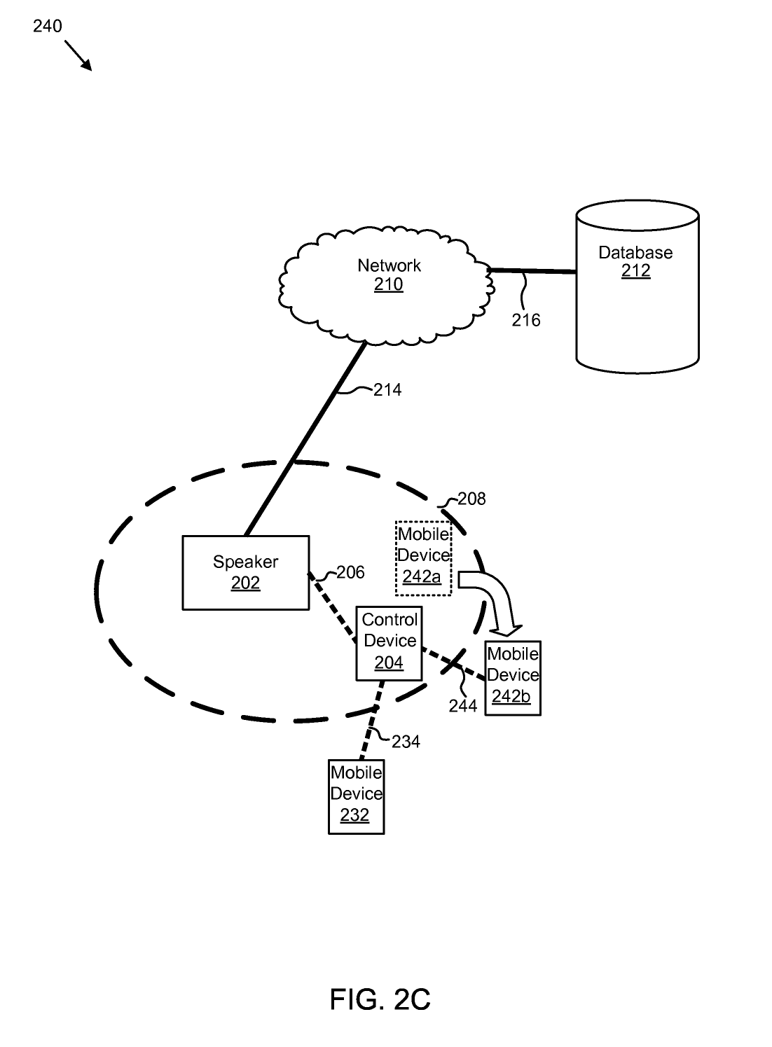

FIG. 2A illustrates another exemplary mobile device speaker control system. In the diagram of FIG. 2A, a system 200 includes speaker 202, control device 204, data paths/connections 206, 214, 216, and 220, threshold 208, cloud/network 210, database 212 (e.g., data sources), and mobile device 218. In some examples, techniques for mobile device speaker control may be implemented for mobile device 218 to control speaker 202 using control device 204, all of which may be in data communication with each other using wired or wireless data communication protocols. In other examples, system 200 and the above-described elements may be implemented differently and are not limited to the functions, structures, or configurations shown and described. In some examples, control device 204 can implement one or more structures and/or functions of controller 117 of FIG. 1A, or other components described herein.

FIG. 2B illustrates yet another exemplary mobile device speaker control system. In the diagram of FIG. 2B, system 230 includes speaker 202, control device 204, data paths/connections 206, 214, 216, 220, and 234, threshold 208, cloud/network 210, database 212, and mobile devices 218 and 232, the latter of which may be in data communication with control device 204 using data connection 234, which may be implemented as a wired, wireless, optical, or other type of data connection. In some examples, techniques for mobile device speaker control may be implemented for mobile device 218 to control speaker 202 using control device 204, all of which may be in data communication with each other using wired or wireless data communication protocols. If one or more other mobile devices (e.g., mobile device 232) are brought in close proximity, but not within threshold 208, speaker control may still be assigned to mobile device 218 or another device with a RSSI that exceeds threshold 208. In other examples, a determination as to which mobile device to assign control may be determined differently and is not limited to comparing RSSI values to threshold 208. For example, control of speaker 202 (e.g., speaker box 102 (FIG. 1B)) may be awarded manually or assigned based on a more complex algorithm. Regardless and, in other examples, system 230 and the above-described elements may be implemented differently and are not limited to the functions, structures, or configurations shown and described.

FIG. 2C illustrates a further exemplary mobile device speaker control system. In the diagram of FIG. 2C, a system 240 includes speaker 202, control device 204, paths/data connections 206, 214, 216, 234, and 244, threshold 208, cloud/network 210, database 212, and mobile devices 232 and 242. In some examples, techniques for mobile device speaker control may be implemented for mobile device 242 to control speaker 202 using control device 204, all of which may be in data communication with each other using wired or wireless data communication protocols. As an example, consider that when mobile device 242 is moved from position 242a to position 242b, which beyond threshold 208, that neither device is within threshold 208. Thus, according to some examples, speaker control of speaker 202 may be configured to remain with the last device (i.e., mobile device 242 when it was at position 242a) to which it was assigned by control device 204. In other examples, system 240 and the above-described elements may be implemented differently and are not limited to the functions, structures, or configurations shown and described.

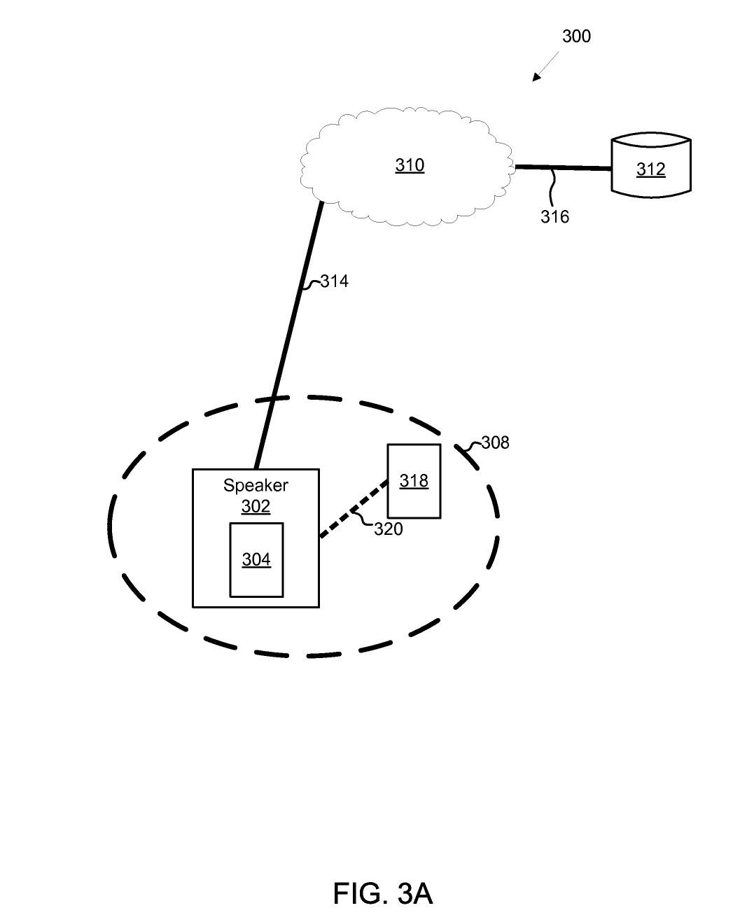

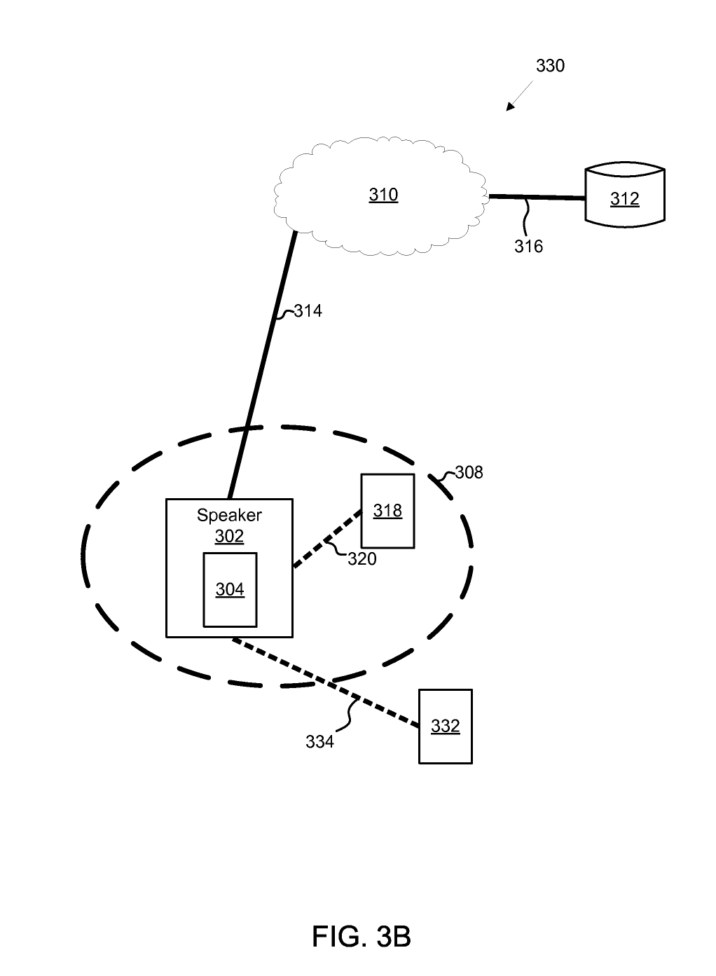

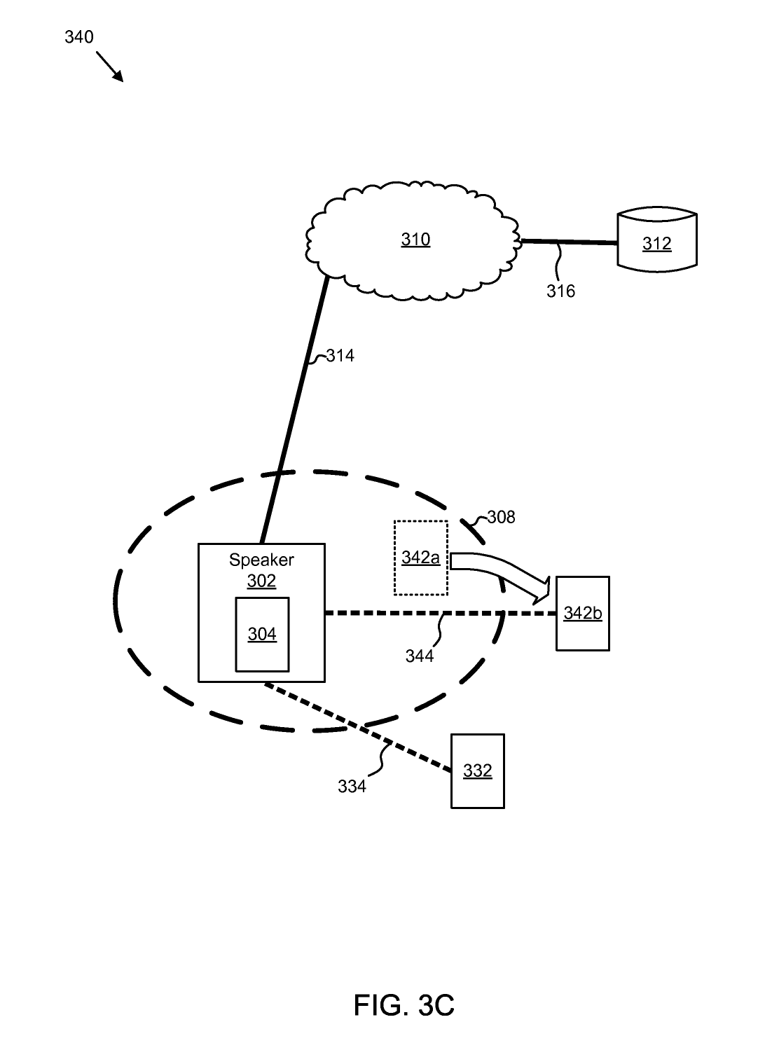

FIGS. 3A to 3C illustrate alternative examples of implementing mobile device speaker control, according to some embodiments. According to at least some examples, components depicted in FIGS. 3A to 3C can include structures and/or functions as similarly-named and/or similarly-numbered components as set forth in FIGS. 2A to 2C, respectively. As depicted in FIGS. 3A to 3C, a control device 304 is implemented within or a part of speaker box 302. In some examples, control device 304 can include structures and/or functions equivalent to that described in controller 117 of FIG. 1A and in other examples described herein.

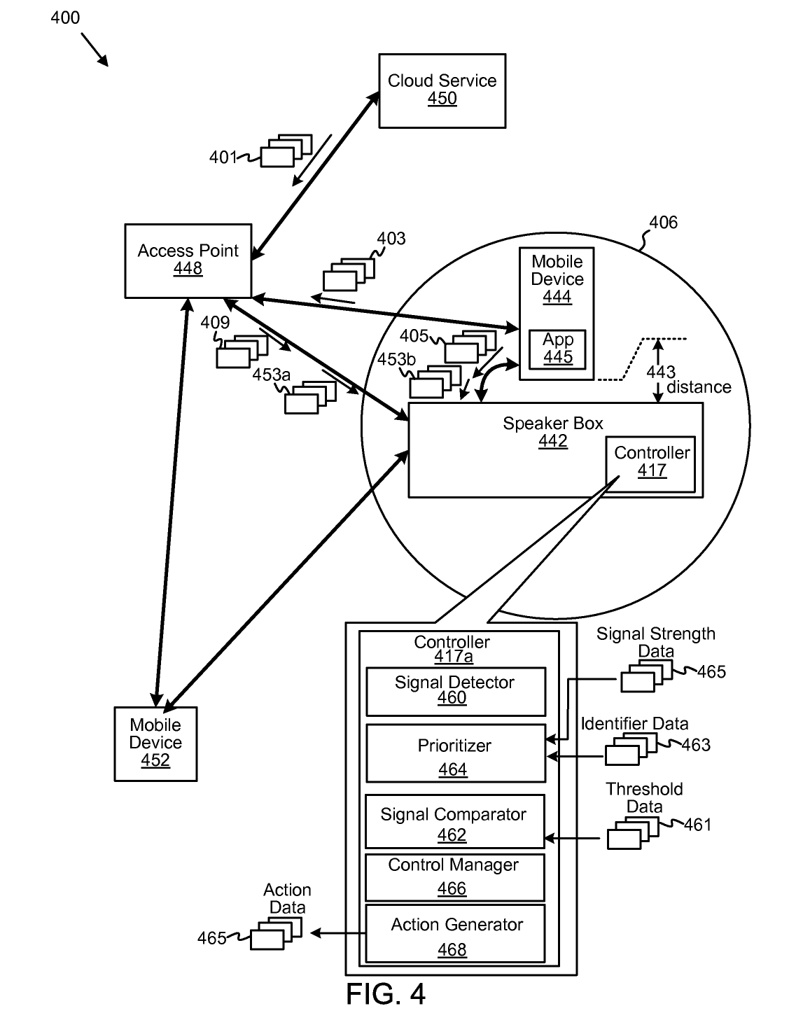

FIG. 4 illustrates an example of a controller configured to implement mobile device speaker control, according to various embodiments. Diagram 400 includes a speaker box 442, a mobile device 444, a boundary 406, a wireless access point 448, a cloud service 450, and a mobile device 452. Speaker box 442, mobile device 444, wireless access point 448, cloud service 450, and mobile device 452, may be configured for wired or wireless data communication over one or more data paths. According to various examples, speaker box 442 includes controller 417, which is configured to facilitate intuitive, seamless control between speaker box 442 and mobile devices 444 and 452 by, for example, detection of a placement one of the mobile devices on top, or in close proximity of, speaker box 442. In some examples, boundary 406 represents, or is related to, a threshold distance, such as distance 443, from a surface of speaker box 442 or any other reference point, such as an internal antenna (not shown). A value of strength of signal (e.g., a representative value of signal power or magnitude, etc.) can correlate with distance 443. As such, a value of signal strength can be used to determine a proximity of a mobile device for which control is transferred, at least in some cases.

Controller 417 can include a signal detector 460, a signal comparator 462, a prioritizer 464, a control manager 466, and an action generator 468, according to various examples. Signal detector 460 may be configured to initiate proximity detection. In some examples, signal detector 460 can receive a signal requesting initiation of proximity detection to determine identities and proximities of one or more mobile devices 444 and 452. A user may press a button or otherwise activate a monitor mode to discover packets from candidate mobile devices. In other examples, signal detector 460 can initiate proximity detection to responsive to detecting one or more identities of one or more mobile devices 444 and 452. Signal detector 460 can also determine one or more characteristics used to determine proximity, such as a signal strength associated with a packet. In some examples, signal detector 460 implements a monitor mode to detect packet traffic without, for example, associating a packet (e.g., via authentication) with an access point or any other device. Thus, signal detector 460 can operate on encrypted or unencrypted packets. During monitor mode, speaker box 442 configures its radio frequency (“RF”) transceiver circuitry to operate in “receive” mode to discover packets that are “visible” (e.g., detectable) to the speaker box 442 even when an RF radio need not be connected to an access point infrastructure, according to some examples.

According to various embodiments, signal detector 460 can communicate with any transceiver circuitry, including RF radios, such as WiFi radio circuitry, Bluetooth® radio circuitry, including Bluetooth Low Energy (“Bluetooth LE”), and/or any other radio devices. To illustrate, consider that signal detector 460 can implement a monitor mode configured to use a WiFi transceiver circuit in speaker box 442 in a receive-only mode to facilitate discovery of WiFi packets, regardless of whether mobile devices 444 and 452 are coupled to an access point, or equivalent. With this mode, the received packets, including encrypted packets, may include information (e.g., characteristics) that can be ascertained, such as an identifier (e.g., a MAC address) associated to the specific mobile device that transmits the packet.

An identifier can be obtained in a variety of ways. In a first example, a mobile device, such as mobile device 444, can include or access (e.g., if external) executable instructions constituting an application (“App”) 445 that can facilitate discovery of mobile device 444 and its characteristics, such as one or more identifiers, a protocol associated with the packet, a power level associated with a signal (e.g., signal strength), etc. In some cases, mobile device 444 can transmit credentials (or loaning credentials, securely) to a speaker box to access third party music streaming services, etc. In one example, application 445, which may be pre-installed (e.g., prior to use/purchase) or downloaded, can emit packets 405 at a periodic rate (or aperiodic rate) of, for example, every 0.5 seconds. Signal detector 460 may determine an identifier, such as a MAC address, and a signal strength value from such packets independent of whether mobile device 444 is coupled to access point 448.

In a second example, signal detector 460 can receive other packets 453b (e.g., on the same or different communication link or data path), such as Bluetooth packets, that include one or more similar characteristics (e.g., a Bluetooth MAC address). In some cases, packets 453b can also include audio data transferred from mobile device 444 to speaker box 442 to playback music. In other examples, mobile device 444 is coupled to access point 448 and can provide data 403 including characteristic data (e.g., an identifier/MAC address) and audio data, whereby application 445 is optional (e.g., need not be necessary to ascertain one or more characteristics) In turn, access point 448 can transmit data 409, including characteristic data, and audio data 453a from mobile device 444 to speaker box 442 for audio consumption (e.g., when mobile device is in proximity).

In yet another example, identifiers of mobiles devices, such as mobile device 444, can be obtained via data 401 by signal detector 460 from cloud services 480, which can include third party music streaming platforms, social networking platform services, etc. For example, MAC addresses of mobile devices 444 and 452 can be sent to cloud service 480, from which speaker box 442 can obtain a list of devices from the cloud service. Signal detector 460 then can filter and use the MAC addresses in the list to acquire identities and other information regarding the mobile devices. As another example, signal detector 460 can generate a list of MAC addresses (e.g., a pre-assigned list of MAC addresses) of mobile devices to be monitored. In some cases, signal detector 460 can generate a historic listing or archive of previously-paired mobile devices that had prior interactions with speaker box 442.

Prioritizer 464 is configured to receive identifier data 463, as a first characteristic, and data 465 representing a signal strength value, as a second characteristic. For example, prioritizer 464 can receive a signal strength value (e.g., from signal detector 460) against which other signal strength values of other mobile devices may be compared. In some embodiments, a signal strength value can be a function of a value of a received signal strength indicator (“RSSI”), which may be a relative measurement of power in a received signal including packets having identifiers. Thus, an RSSI value can be indicative of a distance 443 or a proximity value (e.g., a distance) of a mobile device 444. In some examples, prioritizer 464 can detect MAC addresses of mobile devices 444 and 452, and rank, prioritize, or order associated mobile devices from, for example, the highest RSSI values to the lowest RSSI values. For example, consider that mobile device 444 has a greater RSSI value than mobile device 452. As such, mobile device 444 is ranked higher than mobile device 452. In some embodiments, prioritizer 464 may be optional and need not be implemented in other implementations.

Signal comparator 462 is configured to receive threshold data 461 associated with a characteristic for which a comparison is made to determine whether a mobile device is in proximity. For example, signal comparator 462 can receive a signal strength value (e.g., from signal detector 460 or prioritizer 464) against which threshold data 461 is compared. In some embodiments, a signal strength value can be a value of a received signal strength indicator (“RSSI”). In some cases, threshold data 461 can represent a RSSI threshold level that correlates to distance 443 of mobile device 444 that demarcates boundary/threshold 406 of speaker box 442. For example, consider that signal comparator 462 implements a RSSI threshold level of −10 dBm. Thus, a boundary 406 sets forth a relatively very close proximity (or distance 443) between speaker box 442 and the mobile device. The RSSI threshold, therefore, can represent distance 443 in which mobile device 444 is in contact with, or is substantially in contact with, a surface of speaker box 442. For example, a mobile device set on top of speaker box 442 may be determined as being in “proximity” for purposes of transferring control. Note that any number of values of signal strength or RSSI can be used, such as −55 dBm (or 55 dBm), or any values (e.g., values within +/−50%). Note that a near-field magnetic field of the antenna (a relatively long wire (relative to RF wavelength), or a detuned antenna) may be utilized for sensing proximity.

Control manager 466 is configured to manage the control states of mobile devices 444 and 452, including management of the transfer of control from either speaker box 442 or another mobile device to mobile device 444. For example, control manager 466 can specify that mobile device 444 is in a “sole control” control state in which no other mobile devices can control speaker box 442. Control manager 466 can transfer control to another mobile device, such as mobile device 452, should mobile device 444 moves beyond boundary 406 and mobile device 452 enters boundary 406. In other examples, control manager 466 can specify whether mobile device 444 is in a “principal control” control state in which mobile device 444 has principal control of speaker box 442 and can yield control to other mobile devices based on criteria, such as an approved request (by mobile device 444) to mobile device 452 to assume temporary control (e.g., for playback of one song). In some other examples, control manager 466 can suppress action generator 468 from taking action if, for example, when two or more mobile devices are within proximity (e.g., within boundary 406) of speaker box 442. In this case, the last mobile device having control can remain in control of speaker box 442.

Action generator 468 is configured to initiate or perform an action responsive to control transfer to a mobile device, and a subsequent request for speaker box 442 to perform an action. For example, when a mobile device is within close proximity (e.g., within an RSSI threshold level) of speaker box 452, the speaker box 452 can perform one or more the following actions: 1) access a song that is stored in memory of speaker box 442, 2) speaker box 442 can receive a request or can, on its own initiative, transmit a request via access point 448 (e.g., a Wi-Fi access point) to pull music from cloud service 480, 3) enable mobile device 444 to stream music via access point 448 to speaker box 442, 4) connect speaker box 442 (e.g., directly) to mobile device 444 to access audio data 435b for streaming using, for example, peer-to-peer data transfers via ad-hoc network or Wi-Fi Direct®, which is maintained and specified by Wi-Fi Alliance of Austin, Tex. Also, action generator 468 can generate action data 465 to initiate any of the above-described actions, as well as other actions, like accessing a playlist on mobile device 444, setting up a user's preferred configuration, allowing incoming and/or outgoing voice calls via microphones (not shown) and speakers in speaker box 442. In view of the foregoing, and in a specific example, a packet's MAC address and associated RSSI information (or other distance/proximity information) of the source device (e.g., mobile device 444) and destination device (e.g., speaker box 442) can be determined for purposes of determining whether controller 417a ought to transfer control of speaker box 442.

In some embodiments, controller 417a can be in communication (e.g., wired or wirelessly) with a mobile device 444, such as a mobile phone or computing device. In some cases, a mobile device or any networked computing device (not shown) in communication with a wearable computing device including controller 417a can provide at least some of the structures and/or functions of any of the features described herein. As depicted in FIG. 4 and other figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIG. 4 (or any figure) can represent one or more algorithms. Or, at least one of the elements can represent a portion of logic including a portion of hardware configured to provide constituent structures and/or functionalities.

For example, controller 417a and any of its one or more components, such as a signal detector 460, a signal comparator 462, a prioritizer 464, a control manager 466, and an action generator 468 can be implemented in one or more computing devices (i.e., any audio-producing device, such as desktop audio system (e.g., a Jambox® implementing LiveAudio® or a variant thereof), a mobile computing device, such as a wearable device or mobile phone (whether worn or carried), that include one or more processors configured to execute one or more algorithms in memory. Thus, at least some of the elements in FIG. 4 (or any figure) can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, controller 417a and any of its one or more components, such as a signal detector 460, a signal comparator 462, a prioritizer 464, a control manager 466, and an action generator 468 can be implemented in one or more computing devices that include one or more circuits. Thus, at least one of the elements in FIG. 4 (or any figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

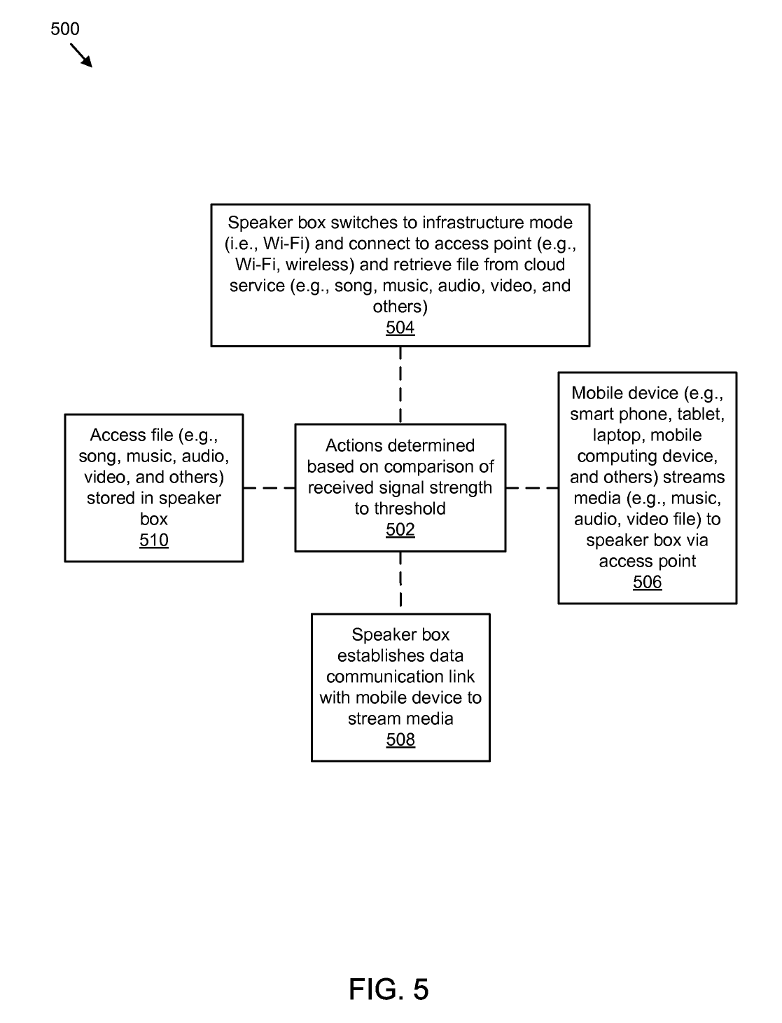

FIG. 5 illustrates some exemplary actions determined using mobile device speaker control, according to some examples. Diagram 500 specifies at 502 that at least some actions can be determined based on comparison of received signal strength to a threshold. At 504, a first action can include facilitating switching a speaker box to an infrastructure mode so that it connects to an access point (e.g., a Wi-Fi wireless access point). When connected, the speaker box can retrieve a file of content (e.g., audio, video, etc.) from a cloud service or other sources of content (e.g., song, music, audio, video, and others). At 506, a third action can cause a mobile device (e.g., smart phone, tablet, laptop, mobile computing device, including wearable computing devices, and others) to stream media (e.g., music, audio, video file, etc.) to a speaker box via an access point. At 508, a fourth action can cause a speaker box to establish a data communication link with a mobile device from which to access content to stream media, such as in a peer-to-peer/ad-hoc manner (e.g., directly). At 510, a fifth action can include speaker box to access internally-stored files in memory, including song files, music files, audio files, video files, and other files) for playback. Other actions can be performed by a speaker box (or any other device) under control of a mobile device as a transferee of control from the speaker box or the other device.

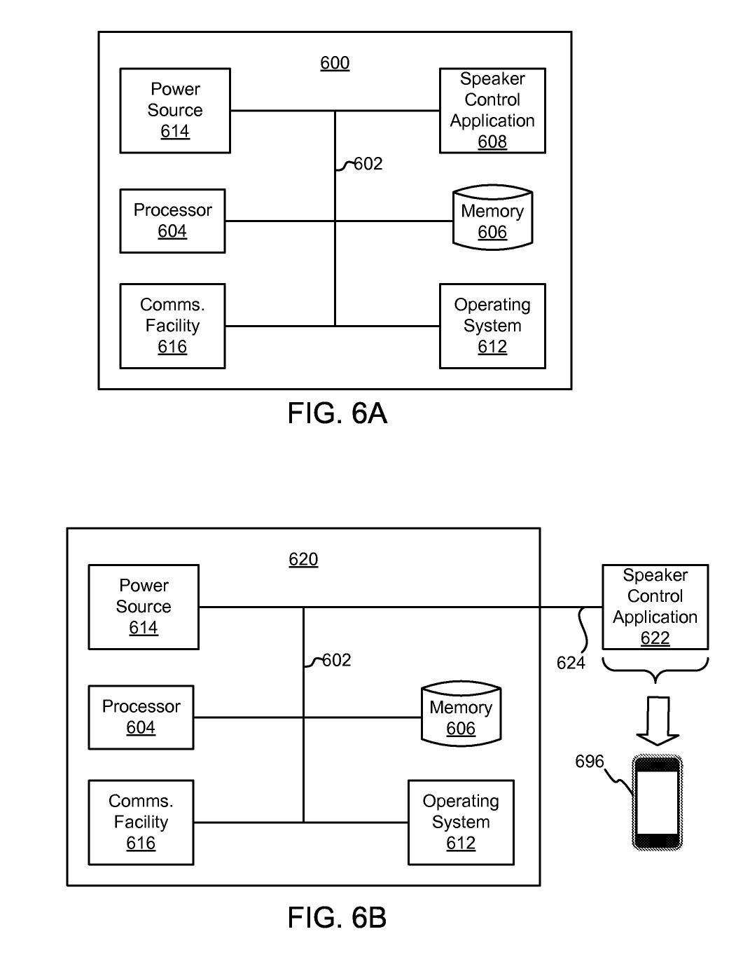

FIG. 6A illustrates an exemplary mobile device architecture for mobile device speaker control, according to some embodiments. The diagram of FIG. 6A is a block diagram of speaker box controller, according to the example shown. Here, speaker box controller 600 includes bus 602, processor 604, memory 606, a speaker control application 608, an operating system 612, a power source 614, and a communications facility 616. In some examples, the quantity, type, function, structure, and configuration of speaker box controller 600 and the elements (e.g., bus 602, processor 604, memory 606, speaker control application 608, operating system 612, power source 614, and communications facility 616) shown may be varied and are not limited to the examples provided. As shown, processor 604 may be implemented as logic to provide control functions and signals to memory 606, speaker control application 608, operating system 612, power source 614, and communications facility 616. Processor 604 may be implemented using any type of processor or microprocessor suitable for packaging within a speaker box controller, such as controller 117 of FIG. 1A. Referring back to FIG. 6A, various types of microprocessors may be used to provide data processing capabilities for speaker box controller 600 and are not limited to any specific type or capability. For example, a MSP430F5528-type microprocessor manufactured by Texas Instruments of Dallas, Tex., among others, may be suitable for implementing at least a portion of speaker box controller 600. Further, different processors may be desired if other functionality (e.g., the type and number of operating systems 612 or other components) are varied. Data processed by processor 604 may be stored using, for example, memory 606.

In some examples, memory 606 may be implemented using various types of data storage technologies and standards, including, without limitation, read-only memory (“ROM”), random access memory (“RAM”), dynamic random access memory (“DRAM”), static random access memory (“SRAM”), static/dynamic random access memory (“SDRAM”), magnetic random access memory (“MRAM”), solid state, two and three-dimensional memories, Flash®, and others. Memory 606 may also be implemented using one or more partitions that are configured for multiple types of data storage technologies to allow for non-modifiable (i.e., by a user) software to be installed (e.g., firmware installed on ROM) while also providing for storage of captured data and applications using, for example, RAM. Once captured and/or stored in memory 606, data may be subjected to various operations performed by other elements of speaker box controller 600.

Speaker control application 608, in some examples, may be implemented to provide control to a mobile device, and receive control instructions from such a device, for generating audio to be communicated under the influence of speaker box controller 600. As used herein, “facility” refers to any, some, or all of the features and structures that are used to implement a given set of functions. Audio signals including audio (e.g., songs, music, etc.) can be emitted directly using speaker control application 608, or indirectly by transmission via communications facility 616 to other audio-capable devices, such as headphones, a headset, a mobile computing device, a computer, a laptop, a distributed operating system, etc.

Power may be stored in power source 614, which may be implemented as a battery, battery module, power management module, or the like. Power may also be gathered from local power sources such as solar panels, thermo-electric generators, and kinetic energy generators, among others that are alternatives power sources to external power for a battery. These additional sources can either power the system directly or can charge a battery, which, in turn, is used to power the system (e.g., of a speaker box controller). In other words, power source 614 may include a rechargeable, expendable, replaceable, or other type of battery, but also circuitry, hardware, or software that may be used in connection with in lieu of processor 604 in order to provide power management, charge/recharging, sleep, or other functions. Further, power source 614 may be implemented using various types of power source technologies, including Lithium Ion (“LI”), Nickel Metal Hydride (“NiMH”), or others, without limitation. Power drawn as electrical current may be distributed from power source via bus 602, the latter of which may be implemented as deposited or formed circuitry or using other forms of circuits or cabling, including flexible circuitry. Electrical current distributed from power source 604 and managed by processor 604 may be used by one or more of memory 606, speaker control application 608, operating system 612, communications facility 616, and the like.

Various operating systems, including operating system 612, may be used as input sources for audio data or signals captured by speaker box controller 600. For example, speaker control application 608 may be used to access audio data from a variety of different sources (e.g., other mobile devices, cloud services, etc.). In addition to speaker control application 608, other operating systems (i.e., operating system 612) may be implemented to control states or boundary determinations for purposes of determining whether to transfer control. As presented here, operating system 612 may include one or multiple operating systems and is not intended to be limiting as to the quantity or type of operating system implemented. Audio/video data processed by speaker box controller 600 using speaker control application 608 and operating system 612, or data requested from another source (i.e., outside of speaker box controller 600), may also be exchanged, transferred, or otherwise communicated using communications facility 616. For example, communications facility 616 may include a wireless radio, control circuit or logic, antenna, transceiver, receiver, transmitter, resistors, diodes, transistors, or other elements that are used to transmit and receive data from speaker box controller 600. In some examples, communications facility 616 may be implemented to provide a wireless data communication capability to transmit digitally encoded data across one or more frequencies using various types of data communication protocols, without limitation. In still other examples, speaker box controller 600 and the above-described elements may be varied in function, structure, configuration, or implementation and are not limited to those shown and described.

FIG. 6B illustrates an alternative exemplary mobile device architecture for mobile device speaker control, according to some embodiments. Here, speaker box controller 620 can include structures and/or functions of at least similarly-named and/or similarly-numbered elements set forth in FIG. 6A. As shown, however, speaker control application 622 is disposed external to speaker box controller 620 and is communicates via communications link 624 to speaker box controller 620. According to some embodiments, speaker control application 622 is disposed in a mobile device, such as mobile device 696.

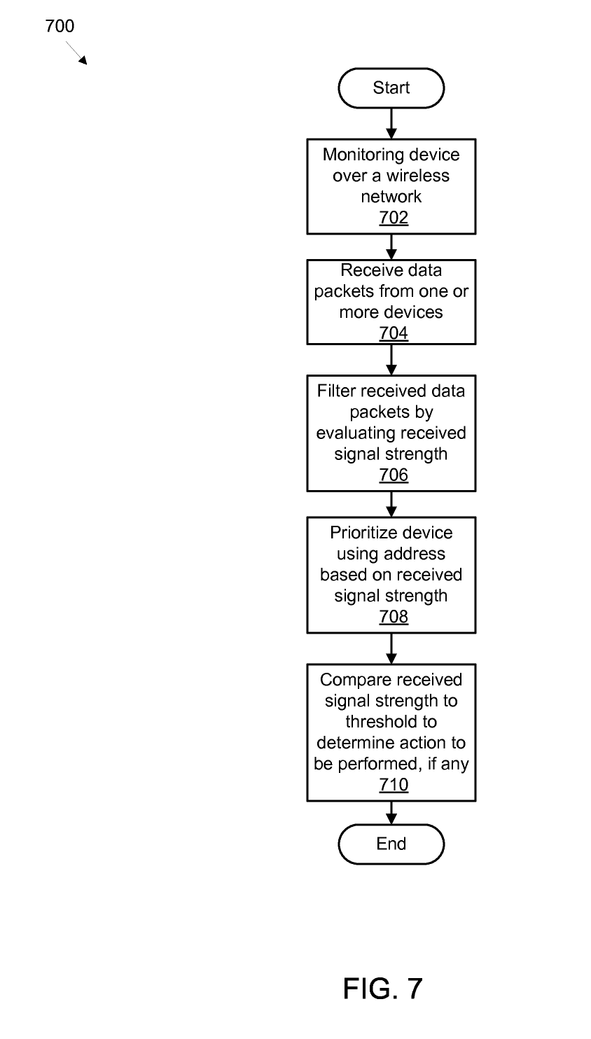

FIG. 7 is an example flow for facilitating mobile device speaker control, according to some embodiments. At 702 of flow 700, a speaker box or other device monitors devices over a wireless network, and receives data packets from one or more devices at 704. At 706, data packets can be filtered by evaluating a proximity of a mobile device, such as a received signal strength. At 708, one or more devices are prioritized against each other based on received signal strength. At 710, a value of received signal strength can be compared to a threshold to determine whether an action to be performed, if any, by a speaker box or other device.

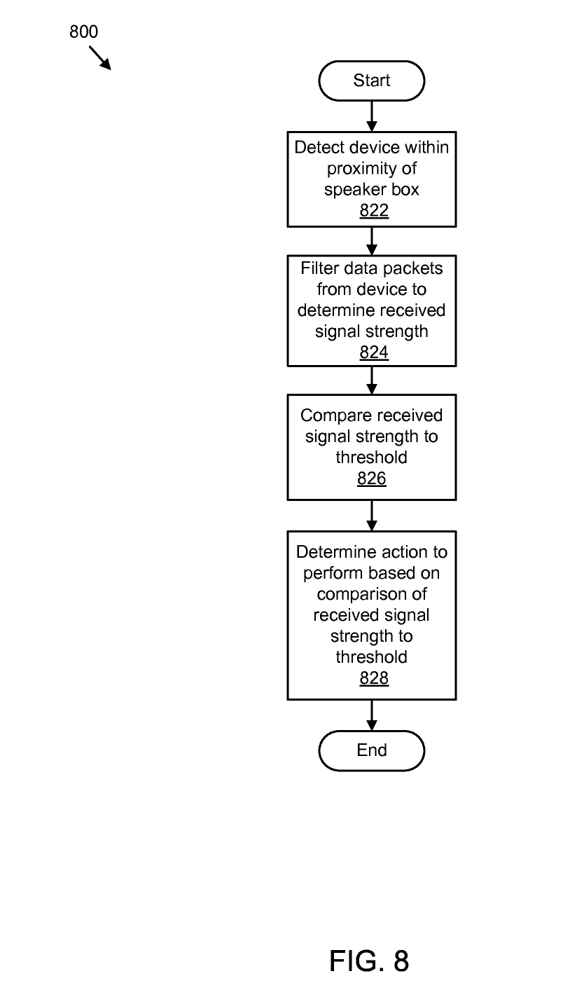

FIG. 8 is an alternative example flow for facilitating mobile device speaker control, according to some embodiments. At 802 of flow 800, a device, such as a mobile or wearable device, is detected within proximity of a speaker box, and data packets are filtered at 824 to determine received signal strength for those packets originating at the device. At 826, a received signal strength is compared to a threshold value, and a determination is made at 828 as to whether an action ought to be performed based on the result of the comparison of received signal strength to threshold.

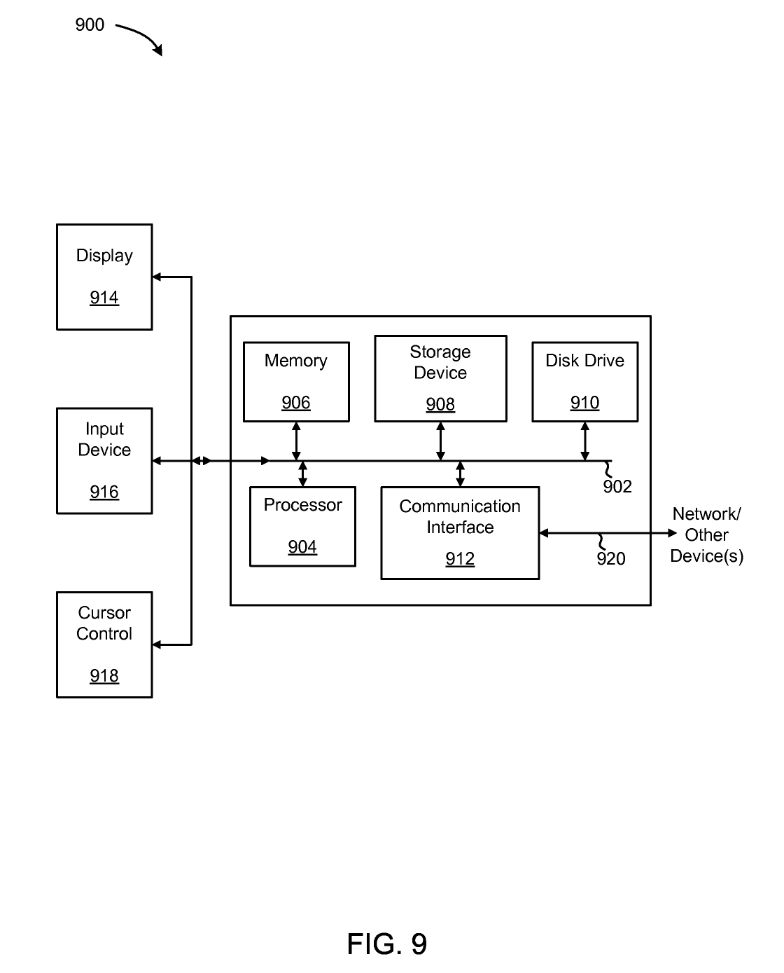

FIG. 9 illustrates an exemplary computer system suitable for use with mobile device speaker control. In some examples, computer system 900 may be used to implement computer programs, applications, methods, processes, or other software to perform the above-described techniques. Computer system 900 includes a bus 902 or other communication mechanism for communicating information, which interconnects subsystems and devices, such as processor 904, system memory 906 (e.g., RAM), storage device 908 (e.g., ROM), disk drive 910 (e.g., magnetic or optical), communication interface 912 (e.g., modem or Ethernet card), display 914 (e.g., CRT or LCD), input device 916 (e.g., keyboard), and cursor control 918 (e.g., mouse or trackball).

According to some examples, computer system 900 performs specific operations by processor 904 executing one or more sequences of one or more instructions stored in system memory 906. Such instructions may be read into system memory 906 from another computer readable medium, such as static storage device 908 or disk drive 910. In some examples, hard-wired circuitry may be used in place of or in combination with software instructions for implementation.

The term “computer readable medium” refers to any tangible medium that participates in providing instructions to processor 904 for execution. Such a medium may take many forms, including but not limited to, non-volatile media and volatile media. Non-volatile media includes, for example, optical or magnetic disks, such as disk drive 910. Volatile media includes dynamic memory, such as system memory 906.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 902 for transmitting a computer data signal.

In some examples, execution of the sequences of instructions may be performed by a single computer system 900. According to some examples, two or more computer systems 900 coupled by communication link 920 (e.g., LAN, PSTN, or wireless network) may perform the sequence of instructions in coordination with one another. Computer system 900 may transmit and receive messages, data, and instructions, including program, i.e., application code, through communication link 920 and communication interface 912. Received program code may be executed by processor 904 as it is received, and/or stored in disk drive 910, or other non-volatile storage for later execution.

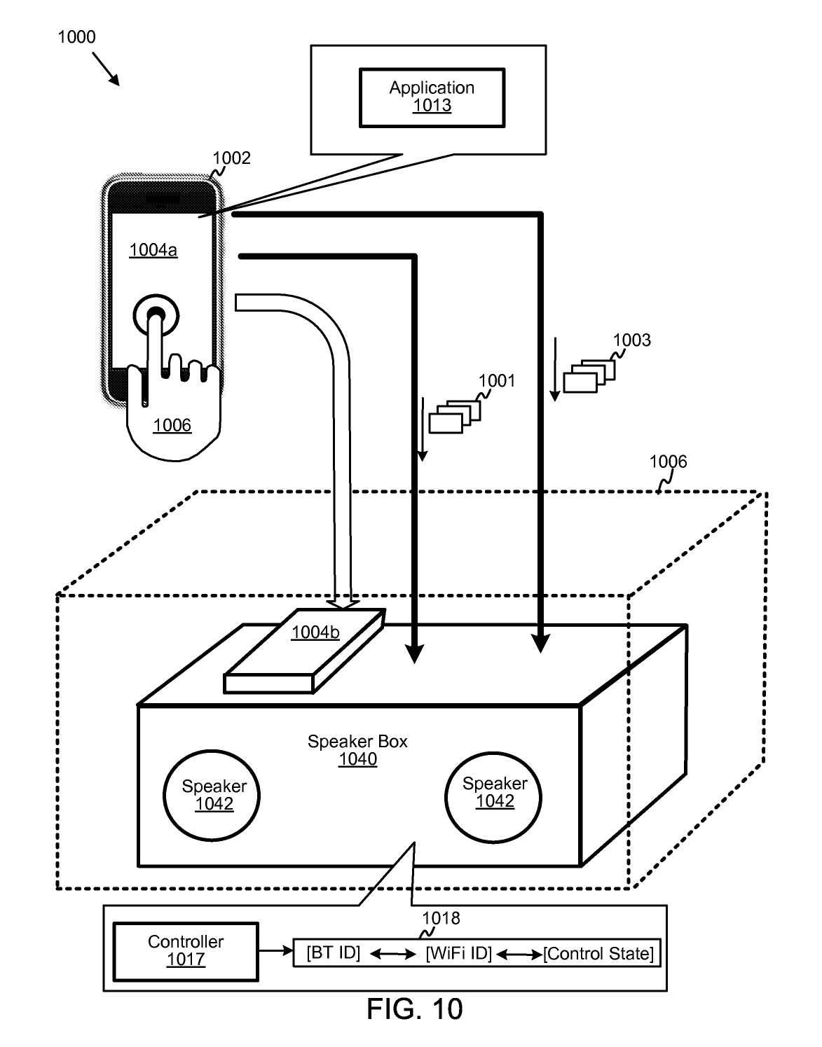

FIG. 10 depicts an alternative example of a controller implemented to facilitate mobile device control of a speaker box, according to some embodiments. Diagram 1000 includes a mobile device 1002 in a first position 1004a and in a second position 1004b, which is on top of, or adjacent to a surface of, a speaker box 1040. Speaker box 1040 includes two or more transducers or speakers 1042 to generate audio under the control of mobile device 1002 when in proximity of speaker box 1040. Mobile device 1002 includes an application 1013 that, when invoked by a user interaction 1006 with an interface (e.g., a touch-sensitive screen), generates packets 1001 over a first communications link and generates packets 1003 over a second communications link. In some embodiments, the first communications link can include a near field communications protocol and the second communications link can include a far field communications protocol. For example, the near field communications protocol can include a Bluetooth protocol and the far field communications protocol can include a Wi-Fi protocol. Other protocols are possible. In at least one alternative embodiment, the first communications link and the second communications link include the same protocol (e.g., both communications link implement a Wi-Fi Direct® link or any other type of communications link).

Controller 1017 can perform any number of operations, including those described herein, to establish control of speaker box by mobile device 1002 when moved in proximity to, or within a region 1006 about, speaker box 1006. Controller 1017 can retrieve a first identifier, such as a Bluetooth address (“BT ID”), via packets 1001, and can obtain a second identifier, such as a Wi-Fi address (“WIFI ID”), via packets 1003. Further, controller 1017 can generate a list of data representing the relationships or associations between identifiers and a control state (e.g., whether a mobile device is in control) for a specific mobile device. This list can be used to manage the transfer of control among mobile devices.

In some embodiments, a near-field communication link can be link that conveys information over, for example, one meter or less. Other ranges are possible. For example, the first communications link can be implemented with NFC technologies based on, for example, a standard for short-range wireless connectivity technology maintained by the NFC Forum of Wakefield, Mass. In other examples, the near-field communications link can implement Bluetooth® or Bluetooth low energy (or Bluetooth LE, or BLE) protocol specification, which is maintained by the Bluetooth® Special Interest Group (“SIG”), Inc., headquartered in Kirkland, Wash., U.S.A. Note that the near-field communications link can be implemented with a sufficiently detuned antenna to, for example, reduce the effective range of the first communications link to a distance that accommodates a close proximity or threshold, such as a distance between the antenna in a speaker box and the top of the surface of the speaker box. As such, a mobile device that is placed on top of the speaker box can be determined as being “within the threshold.” In some embodiments, a far-field communication link can be link that conveys information over, for example, ranges that exceed that of the near-field communication link. Examples include Wi-Fi technologies, such as those maintained by Wi-Fi Alliance® of Austin, Tex. Other far-field communication protocols may also be used.

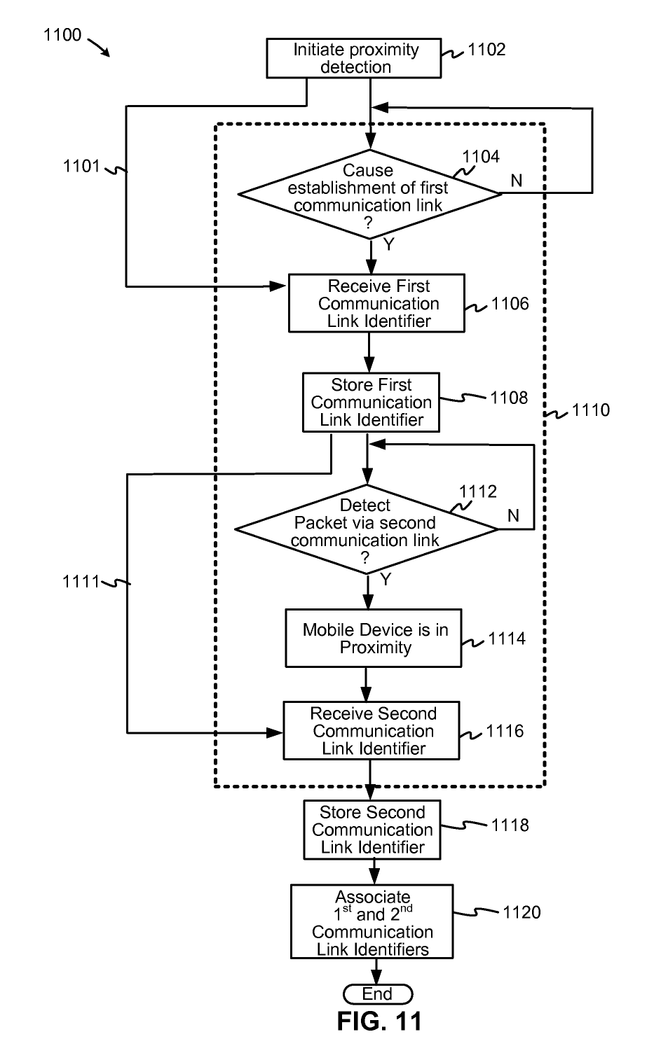

FIG. 11 is an example flow for facilitating mobile device speaker control, according to some embodiments. In some examples, flow 1100 facilitates registration of a mobile device with a speaker box such that the speaker box is aware of the mobile device and includes one or more identifiers that identify the mobile device. At 1102 of flow 1100, a speaker box or other device initiates proximity detection. In some examples, a speaker box transitions into a monitor mode (e.g., a Wi-Fi monitor mode) to capture data packets. While entering the monitor mode can be automatic, a user may initiate proximity detection by invoking an application on a mobile device or by pressing a button (or any other type of input) on a speaker box. In some examples, a second communications link can be established, from which a second identifier via the second communication link can be received (e.g., during monitor mode). Further, data representing the first identifier can be associated with data representing the second identifier to identify the mobile computing device using at least two identifiers. In one embodiment, the second communications link is a Wi-Fi communications link and the second identifier is a Wi-Fi MAC address, which is associated with, for example, a Bluetooth MAC address.

At 1104, a determination is made as to whether a first communication link between a speaker box and a mobile computing device is established. Flow 1100 can continue the determination until the first communication link is established. In some examples, the first communication link is a near-field communications link, such as, but limited to, a Bluetooth® communications link. In this case, a user can invoke an application on a mobile device to initiate a Bluetooth pairing operation with the speaker box. At 1106, a first identifier can be received via the first communication link from the mobile computing device. An example of a first identifier is a Bluetooth MAC address. Note that in some examples, path 1101 may be traversed to receive the first identifier without establishing the first communication link. At 1108, the first identifier can be stored in association with other identifiers or characteristics.

At 1112, a determination is made as to whether a packet via a second communication link is detected. Flow 1100 continues until a packet is detected. For example, a Wi-Fi packet transmitted via a second communications link can be captured to extract a variety of characteristics, including MAC addresses and signal strength information, and the like. At 1114, a mobile device is determined to be in a range of proximity of a speaker box (e.g., at a first point in time). In some examples, a speaker box receives a radio frequency (“RF”) signal including packets including a second identifier from the mobile computing device via the second communication link. A signal strength can be determined based on reception of the packets (e.g., Wi-Fi packets) including the second identifier. To confirm a mobile device is in a range of proximity values, a value of the signal strength can be compared against a threshold value, such as 55 dB, or any other threshold value. If the value of the signal strength exceeds the threshold value, data representing an indication that the mobile computing device is the range of proximity can be generated. At 1116, the second identifier can be received. Note that in some examples, path 1111 may be traversed to receive the second identifier without establishing the second communication link. At 1118, the second identifier can be stored in association with other identifiers or characteristics. At 1120, the first and second identifiers (e.g., the Bluetooth MAC address and the Wi-Fi MAC address) can be associated to each other.

In some examples, the establishment of the first communication link between the speaker box and the mobile computing device, and the determination that the mobile computing device is in the range of proximity of the speaker box occurs in a registration duration of time 1110. For example, portion of flow 1100 from 1104 to 1116, is occurring or overlapping during a registration time 1110, then the first and second identifiers can be linked together. For example, consider that a user invokes an application that generates both WiFi packets and Bluetooth packets during the establishment of the first communication link. Should it be determined that the device generating the WiFi is within a boundary/threshold during a Bluetooth exchange of data (e.g., pairing), then MAC addresses from the first and second communications links are determined to originate from the same mobile device, according to some examples.

Upon determining a mobile device is in proximity, control of the speaker box may be transferred to the mobile computing device as a function of the range of proximity. For example, the mobile device can send a request to play audio, and a speaker box can determine, responsive to the request, a selection of audio associated with the mobile computing device. The speaker box, under control of the mobile device, can cause generation of the audio at the speaker box. The audio can be accessed from audio stored in the mobile computing device.

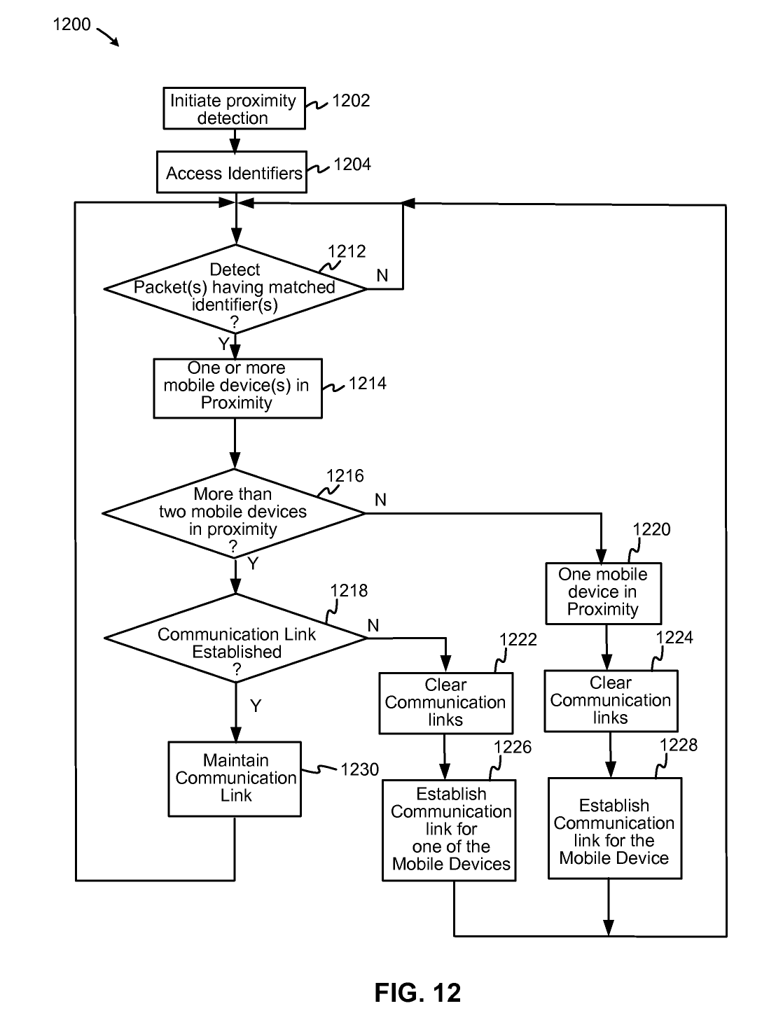

FIG. 12 is an alternative example flow for facilitating mobile device speaker control, according to some embodiments. In some examples, flow 1200 facilitates selection of a mobile device to control a speaker box. At 1202 of flow 1200, a speaker box or other device initiates proximity detection, and identifiers, such as Bluetooth and Wi-Fi MAC addresses (or an address associated with any communications protocol), are accessed. A list can be generated for matching sniffed or captured packets to determine at 1212 whether packets received by a speaker box match packets associated with mobile devices on the list. If there is a matched identifier (e.g., packets from a previously-registered mobile device are detected when compared against the list), then flow 1200 proceeds to 1214, at which one or more mobile devices are deemed to be in proximity of a speaker box.

At 1216, a determination is made whether two or more mobile devices are in proximity of a speaker box. If there are more than one mobile device, then flow 1200 determines whether a communication link exists at 1218 (e.g., whether a first communications link, such as a Bluetooth link, exists). If so, then the communications link is maintained at 1230. Therefore, if two mobile devices are associated with signal strengths (e.g., RSSI values) indicating that they are within a RSSI threshold, then flow 1200 takes no action. In some examples, a mobile device can be determined at 1216 to be in the range of proximity at a second point in time, an indication that the mobile device is in control is maintained, and the first communications link with the mobile device can also be maintained.

If there is not a communication link existing at 1218, then flow 1200 continues to 1222 at which communication links, such as Bluetooth links, are cleared or disconnected. At 1226, a communication link is established (e.g., a Bluetooth link is established) for a mobile device in a “principal” or “sole” control state. For example, the first (in time) mobile device that exceeds the RSSI threshold is deemed in control of a speaker box, with later or subsequent mobile devices either not having control or having subservient/lesser control under the first mobile device. If at 1216 only one mobile device is in proximity, flow 1200 proceeds to 1220 at which a mobile device is identified as being in proximity (i.e., a range of distances) to the speaker box. When the mobile device is identified as a “new” mobile device in control (e.g., a previous mobile device in control is moved outside the proximity/boundary), then communication links are cleared at 1224 in preparation to establish a communication link between the “new” mobile device and a speaker box at 1228.

In one example, consider that flow 1200 provides for a determination that another mobile device is the range of proximity at a third point in time, but the first mobile device remains in control such that an indication and a first communications link is maintained. Should a determination indicate that the first mobile device is moved beyond the range of proximity at 1218, then a speaker box can transfer control to another mobile device (i.e., a second-in-time mobile device in proximity).

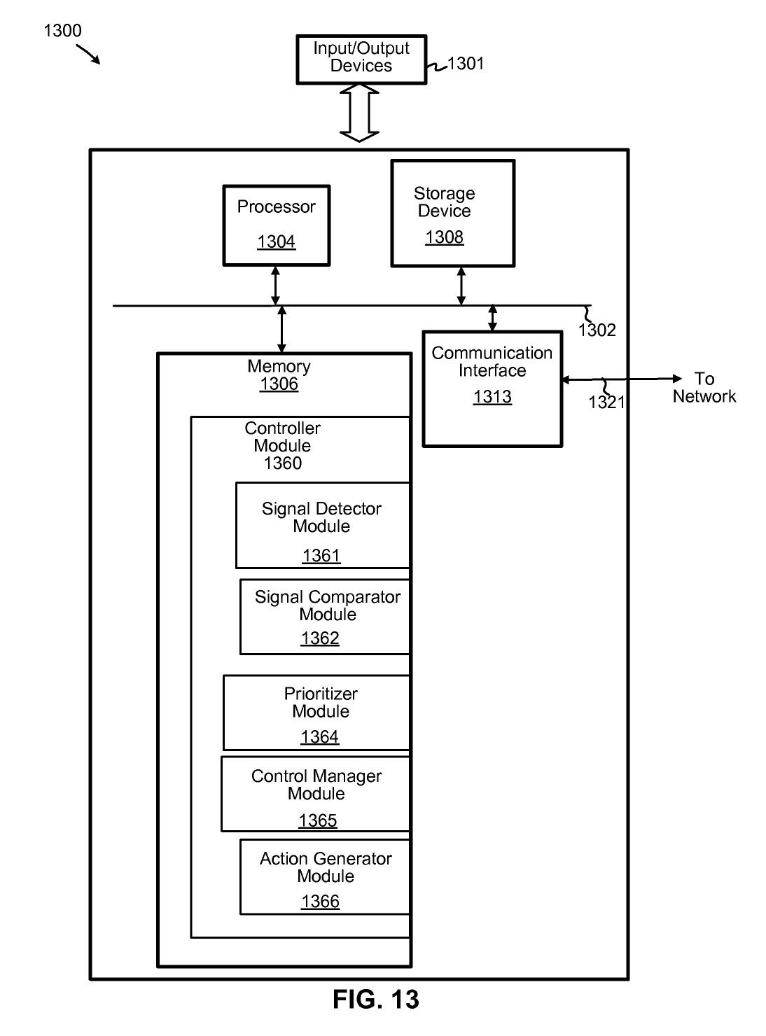

FIG. 13 illustrates an exemplary computing platform in accordance with various embodiments. In some examples, computing platform 1300 may be used to implement computer programs, applications, methods, processes, algorithms, or other software to perform the above-described techniques. Computing platform 1300 includes a bus 1302 or other communication mechanism for communicating information, which interconnects subsystems and devices, such as processor 1304, system memory 1306 (e.g., RAM, etc.), storage device 1308 (e.g., ROM, etc.), a communication interface 1313 (e.g., an Ethernet or wireless controller, a Bluetooth controller, etc.) to facilitate communications via a port on communication link 1321 to communicate, for example, with a computing device, including mobile computing and/or communication devices with processors. Processor 1304 can be implemented with one or more central processing units (“CPUs”), such as those manufactured by Intel® Corporation, or one or more virtual processors, as well as any combination of CPUs and virtual processors. Computing platform 1300 exchanges data representing inputs and outputs via input-and-output devices 1301, including, but not limited to, keyboards, mice, audio inputs (e.g., speech-to-text devices), user interfaces, displays, monitors, cursors, touch-sensitive displays, LCD or LED displays, and other I/O-related devices. An interface is not limited to a touch-sensitive screen and can be any graphic user interface, any auditory interface, any haptic interface, any combination thereof, and the like.

According to some examples, computing platform 1300 performs specific operations by processor 1304 executing one or more sequences of one or more instructions stored in system memory 1306, and computing platform 1300 can be implemented in a client-server arrangement, peer-to-peer arrangement, or as any mobile computing device, including smart phones and the like. Such instructions or data may be read into system memory 1306 from another computer readable medium, such as storage device 1308. In some examples, hard-wired circuitry may be used in place of or in combination with software instructions for implementation. Instructions may be embedded in software or firmware. The term “computer readable medium” refers to any tangible medium that participates in providing instructions to processor 1304 for execution. Such a medium may take many forms, including but not limited to, non-volatile media and volatile media. Non-volatile media includes, for example, optical or magnetic disks and the like. Volatile media includes dynamic memory, such as system memory 1306.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1302 for transmitting a computer data signal.

In some examples, execution of the sequences of instructions may be performed by computing platform 1300. According to some examples, computing platform 1300 can be coupled by communication link 1321 (e.g., a wired network, such as LAN, PSTN, or any wireless network) to any other processor to perform the sequence of instructions in coordination with (or asynchronous to) one another. Computing platform 1300 may transmit and receive messages, data, and instructions, including program code (e.g., application code) through communication link 1321 and communication interface 1313. Received program code may be executed by processor 1304 as it is received, and/or stored in memory 1306 or other non-volatile storage for later execution.

In the example shown, system memory 1306 can include various modules that include executable instructions to implement functionalities described herein. In the example shown, system memory 1306 includes a controller module 1360, which, in turn, includes a signal detector module 1362, a signal comparator module 1364, a prioritizer module 1365, a control manager 1367, and an action generator 1368.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
detecting a device within a proximity of a speaker box coupled to a data network;
filtering a data packet received from the device to determine a received signal strength associated with the device;
comparing the received signal strength to a threshold; and
determining whether an action is to be performed based on a result of the comparing the received signal strength to the threshold.

2. The method of claim 1, wherein the device is a mobile device.

3. The method of claim 1, wherein the proximity of the device to the speaker box is used to determine a priority associated with the device.

4. The method of claim 1, wherein the threshold is based on a received signal strength indicator.

5. The method of claim 1, wherein the action is streaming media from a networked resource.

6. The method of claim 1, wherein the action is streaming media from a cloud service.

7. The method of claim 1, wherein the action comprises accessing a file stored in a memory associated with the speaker box.

8. The method of claim 1, further comprising establishing data communication with an access point configured to transmit data using a wireless data communication protocol.

9. The method of claim 8, wherein an audio file is retrieved using the access point when the received signal strength is greater than the threshold, the audio file being rendered audible by the speaker box.

10. The method of claim 1, wherein an audio file is retrieved using an access point when the received signal strength, when compared, is greater than the threshold, the audio file being rendered audible by the speaker box.

11. A system, comprising:
a memory configured to store data transmitted over a data network; and
a processor configured to detect a device within a proximity of a speaker box coupled to the data network, to filter a data packet received from the device to determine a received signal strength associated with the device, to compare the received signal strength to a threshold, and to determine whether an action is to be performed based on a result of the comparing the received signal strength to the threshold.

12. The system of claim 11, wherein the processor is further configured to:
assign the device control over the speaker box based on the result indicating threshold level is surpassed.

13. The system of claim 12, wherein the processor is further configured to:
perform an action responsive to the result of comparing the received signal strength to the threshold.

14. A computer program product embodied in a computer readable medium and comprising computer instructions for:
detecting a device within a proximity of a speaker box coupled to a data network;
filtering a data packet received from the device to determine a received signal strength associated with the device;
comparing the received signal strength to a threshold; and
determining whether an action is to be performed based on a result of the comparing the received signal strength to the threshold.

15. The computer program product of claim 14, wherein the computer instructions further comprise computer instructions for:
assign the device control over the speaker box based on the result indicating threshold level is surpassed.

16. The computer program product of claim 15, wherein the computer instructions further comprise computer instructions for:
perform an action responsive to the result of comparing the received signal strength to the threshold.

17. The computer program product of claim 14, wherein the computer instructions further comprise computer instructions for:
establish data communication with an access point configured to transmit data using a wireless data communication protocol.

18. The computer program product of claim 17, wherein an audio file is retrieved using the access point when the received signal strength is greater than the threshold, the audio file being rendered audible by the speaker box.
